(19) United States
(12) Patent Application Publication
(10) Pub. No.: US 2016/0186864 A1
(43) Pub. Date: Jun. 30, 2016

(54) SEALING RING

(71) Applicant: AKTIEBOLAGET SKF, Göteborg (SE)

(72) Inventor: Hans-Joachim vom Stein, Odenthal (DE)

(73) Assignee: Aktiebolaget SKF, Göteborg (SE)

(21) Appl. No.: 14/911,772

(22) PCT Filed: Jul. 17, 2014
(86) PCT No.: PCT/EP2014/065443

§ 371 Date: Feb. 12, 2016

(30) Foreign Application Priority Data
Aug. 13, 2013 (DE) 102013215973.0

(51) Int. Cl. F16J 15/3284; F16J 15/3208

(52) U.S. Cl. CPC F16J 15/3284; F16J 15/3208

(57) ABSTRACT

A seal ring includes an annular elastomer body and an annular metal reinforcement at least partially embedded in the elastomer body. The metal reinforcement includes a predominantly radially oriented part and a predominantly axially oriented part, and an end of the predominantly axially oriented part spaced from the predominantly radially oriented part is elastically deformable in a radial direction by more than 2% of a distance from the predominantly radially oriented part to the end of the predominantly axially oriented part.

Exemplary embodiments relate to a seal ring and in particular to a radial shaft seal ring.

In machines including moving or rotating parts there is the problem that the moving or rotating parts must be supported or guided through openings. Here it is often necessary to seal off a region on one side of a guide-through from a region on the other side of the guide-through since one side, for example, contains liquid that should not escape via the guide-through, or the other side has a dirt- or dust-laden environment, and this dirt or dust should not penetrate into the machine via the guide-through. In order to seal off such guide-throughs of moving or rotating parts, seal rings, for example, can be used that are attached in the guide-through bore and are in contact with the moving or rotating part and thereby seal off the two sides of the guide-through from each other.

In order to achieve a static sealing between the receiving bore and the seal ring, the outer diameter of the seal ring is usually selected slightly larger than the diameter of the receiving bore. For example, rubberized outer seats of radial shaft seal rings according to DIN 3760 can serve for the static sealing for the receiving bore and the tolerance compensation of seal and bore. In the range between 50 and 120 mm the percentage coverages fall, for example, between approx. 9.5 and 22 percent. With static seals, such as, for example, O-rings, the technically feasible compression limits fall between 15 and 40 percent (the thickness of the earring). Below 15 percent the seal can be leaky; above 40 percent the seal can be destroyed. The comparison already shows that the lower compression limit is critical here. The upper limit is usually not feasible since the radial shaft seal ring must be pushed into the bore. Due to the viscoelastic behavior of elastomers the compression force is also a function of time. Therefore with the press-in speeds feasible in practice, high press-in forces arise. Therefore in the installed state after the abating of the viscous force component the compressions tend towards too low.

In practice, the problems mentioned become evident on the one hand due to misalignment of the radial shaft seal ring after installation, caused by high pressing forces, and falling-out of seals, for example, during coating of housings. The aluminum housing thereby heats up. The bore becomes larger and the overlap decreases, e.g., by a further 4 percent, while the pressure of the heated air pushes the radial shaft seal ring out of the bore. Meanwhile, for example, in the industrial sector the receiving bore is provided with a sharp-edged groove that should prevent a falling-out. Only in the automotive sector are there fewer problems due to automated assembly.

However, there is also a need to provide a seal ring that allows assembly to be simplified and the reliability of the seal function of the seal ring to be increased.

This object is achieved by a seal ring according to claim 1.

A seal ring according to an exemplary embodiment, in particular a radial shaft seal ring, includes an annular elastomer body and an annular metal reinforcement at least partially embedded in the elastomer body. The metal reinforcement comprises a predominantly radially oriented part and a predominantly axially oriented part. The predominantly axially oriented part is configured such that on an end facing away from the predominantly radially oriented part the predominantly axially oriented part is elastically deformable in the radial direction by more than 2 percent of a distance between the predominantly radially oriented part and the end of the predominantly axially oriented part facing away from the predominantly radially oriented part.

Exemplary embodiments are based on the recognition that the installation of the seal ring can be made significantly easier, and the reliability of the seal function can be increased, by an elastically deformable design of the predominantly axially oriented part of the metal reinforcement. This can be ensured since in comparison to the use of a rigid metal reinforcement (<0.1% elastically deformable) significantly less force needs to be expended in order to insert the seal ring into the receiving bore. The tolerance-compensating function as well as the holding force in the bore is not just assumed exclusively by the elastic body, in particular that part that lies between the metal reinforcement and the receiving bore, but also by the elastically-deformable-in-the-radial-direction metal reinforcement. Due to the use of the described metal reinforcement a significantly flatter and more-independent-from-the-viscoelastic-behavior-of-the-elastomer spring characteristic curve can be achieved. Overall the described seal ring can thus be installed significantly more easily with significantly higher minimum holding forces in the bore. Due to the simple installation the reliability of the positioning of the seal ring in the receiving bore can also be increased and a misalignment can be more easily prevented.

In some exemplary embodiments on the end facing away from the predominantly radially oriented part the predominantly axially oriented part is formed wave-shaped along the circumference of the seal ring. It can thereby be ensured that on the end facing away from the predominantly radially oriented part the predominantly axially oriented part is elastically deformable by more than 2 percent of the distance between the predominantly radially oriented part and the end of the predominantly axially oriented part facing away from the predominantly radially oriented part.

In further exemplary embodiments the predominantly axially oriented part includes slots along the circumference of the seal ring. The slots extend towards the predominantly radially oriented part from the end of the predominantly axially oriented part facing away from the predominantly radially oriented part. Due to the design the elastic deformability in the radial direction of the predominantly axially oriented part can in turn be ensured.

Some exemplary embodiments comprise a metal reinforcement that is configured one-piece. Optionally the metal reinforcement can be a stamped metal plate.

Exemplary embodiments of the present invention are explained in more detail below with reference to the accompanying Figures:

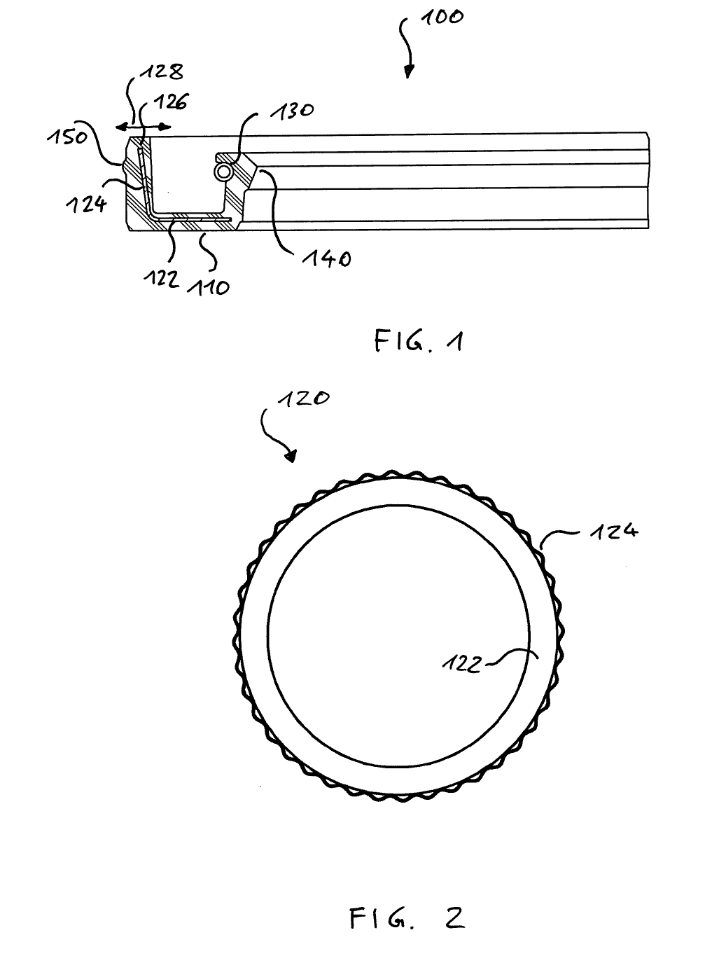

FIG. 1 shows a schematic cross-section through a seal ring.

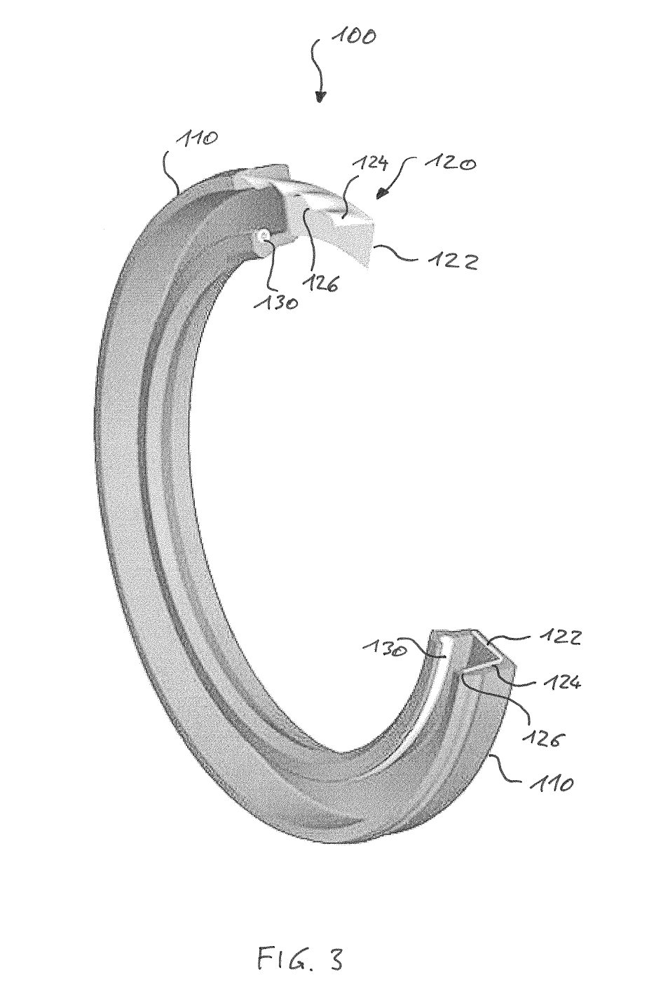

FIG. 2 shows a view of a metal reinforcement of a seal ring; and

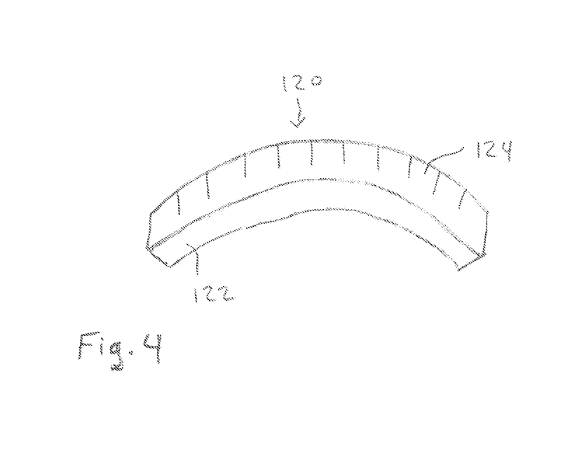

FIG. 3 shows a schematic three-dimensional view of a part of a seal ring.

In the following, the same reference numbers can sometimes be used with various described exemplary embodiments for objects and functional units which have the same or similar functional properties. Furthermore, optional features of the different exemplary embodiments can be combinable or interchangeable with one another.

FIG. 1 shows a schematic cross-section of a seal ring 100 as an exemplary embodiment. The seal ring 100 includes an annular elastomer body 110 and an annular metal reinforcement 120 at least partially embedded in the elastomer body 110. The metal reinforcement 120 comprises a predominantly radially oriented part 122 and a predominantly axially oriented part 124. The predominantly axially oriented part 124 is configured such that on an end 126 facing away from the predominantly radially oriented part 122 the predominantly axially oriented part 124 is elastically deformable in the radial direction by more than 2 percent of a distance (extending along the predominantly axially oriented part) between the predominantly radially oriented part 122 and the end 126 of the predominantly axially oriented part 124 facing away from the predominantly radially oriented part 122. Here the seal ring 100 can in particular be a radial shaft seal ring or another seal ring for sealing a guide-through or supporting of a moving or rotating machine part.

Due to the elastic deformability of the metal reinforcement 120 the installation of the seal ring 100 in a receiving bore can be significantly simplified, and nevertheless a minimum holding force can be ensured in order to hold the seal ring 100 at its position in the receiving bore. This can be ensured since in comparison to the use of a rigid metal reinforcement (<0.1% elastically deformable) significantly less force needs to be expended in order to insert the seal ring into the receiving bore. The tolerance-compensating function as well as the holding force in the bore can also be assumed by the elastically-deformable-in-the-radial-direction metal reinforcement. Due to the simple installation the reliability of the positioning of the seal ring in the receiving bore can also be increased and a misalignment can be more easily prevented.

The metal reinforcement 120 is at least partially embedded in the elastomer body 110 and significantly contributes to the stabilizing of the shape of the seal ring.

The metal reinforcement 120 includes a predominantly radially oriented part 122 and a predominantly axially oriented part 124. The seal ring 100 preferably has a round geometry but can also be, for example, rectangular or square. A geometric midpoint of the seal ring 100 can be defined independent of the basic geometry of the seal ring 100. A radial direction then leads from this midpoint to a point of the seal ring or from a point of the seal ring to the midpoint. The axial direction is orthogonal to the radial direction and leads from one side of the seal ring 100 to the other side of the seal ring 100. For example, with a rotating shaft that extends through a round seal ring 100, the rotational axis extends parallel to the axial direction. According to this definition of the axial and the radial direction a part is predominantly radially oriented if its extension in the radial direction in a radial cross-section through the seal ring 100 is greater than in the axial direction. Conversely, a part is predominantly axially oriented if its extension in the axial direction in a radial cross-section is greater than in the radial direction. Here a radial cross-section is a cross-section through the seal ring 100 along a plane that extends through the midpoint, i.e., is radial, and is parallel in its other extension to the axial direction. In other words, a predominantly radially oriented part of the metal reinforcement 120 in a radial cross-section encloses an angle of less than 45° with the radial direction. Conversely, a predominantly axially oriented part 124 of the metal reinforcement 120 in a radial cross-section encloses an angle of less than 45° with the axial direction.

The predominantly radially oriented part 122 and the predominantly axially oriented part 124 are connected to each other at a connection point. The predominantly axially oriented part 124 extends out from this connection point away from the predominantly radially oriented part 122 up to an end 126 facing away from the predominantly radially oriented part 122. Thus a distance can be defined between the predominantly radially oriented part 122 (or the connection point between the predominantly radially oriented part and the predominantly axially oriented part) and the end 126 of the predominantly axially oriented part 124 facing away from the predominantly radially oriented part 122. Since the seal ring 100 is annular and the extension of the predominantly axially oriented part 124 can vary over the circumference of the seal ring 100, the previously defined distance can refer, for example, to a minimum distance, an average distance, or a maximum distance of the predominantly radially oriented part 122 and of the end 126 of the predominantly axially oriented part 124 facing away from the predominantly radially oriented part 122 in a radial cross-section.

A completely radially oriented part would therefore be a part that is oriented with its longest extension in the radial cross-section parallel to the radial direction, and a completely axially oriented part would therefore be a part that is oriented with its longest extension in the radial cross-section in the axial direction. For example, the metal reinforcing can in include a completely radially oriented part 122 and a predominantly axially oriented part 124.

Radial direction vectors can extend in the complete angular range of 360° about the midpoint; however, they all fall in a plane with the midpoint and the seal ring 100.

The predominantly axially oriented part 124 is configured such that it is elastically deformable in the radial direction 128 on its end 126 by more than 2 percent of the previously defined distance. If an even higher elasticity is required for the respective application, the predominantly axially oriented part 124 can also be configured such that it is elastically deformable in the radial direction 128 on an end 126 facing away from the predominantly radially oriented part 122 by more than 3 percent, 5 percent, 8 percent, 10 percent, or more of the previously defined distance.

In order to ensure the elastic deformability of the predominantly axially oriented part 124 on the end 126 facing away from the predominantly radially oriented part 122, the predominantly axially oriented part 124 can have different geometric shapes.

For example, the predominantly axially oriented part 124 on the end 126 facing away from the predominantly radially oriented part 122 can be configured wave-shaped along the circumference of the seal ring 100, as is shown, for example, in FIG. 2. In other words, a circumferential edge of the metal reinforcement 120 on the end 126 facing away from the predominantly radially oriented part 122 can have a radius varying between a smallest radius and a largest radius (e.g., periodic).

For this purpose the predominantly axially oriented part 124 can transition from a round geometry at the connection point with the predominantly radially oriented part 122 to a wavy shape on the end 126 facing away from the predominantly radially oriented part 122, so that a bottle-cap structure arises. Alternatively, the predominantly axially oriented part 124 can already connect in a wave-shaped geometry to the predominantly radially oriented part 122 and extend in wavy shape up to the end 126 facing away from the predominantly radially oriented part 122. Due to the wavy shape of the predominantly axially oriented part 124, this part 124 shows a significantly larger elastic region on its end 126 with respect to radial deformations or forces than with a circular geometry without a wave-shaped circumference. During inserting into a receiving bore a radial force acts on the seal ring 100 and thus also on the metal reinforcing 120, which radial force presses the predominantly axially oriented part 124 inward. Due to the wave-shaped design the predominantly axially oriented part 124 can elastically deform in a similar manner to a spring by the waves being pressed together, i.e. the length of a wave is reduced along its circumference. If an elastic deformability of, e.g., more than 5% or more than 8% of the previously defined distance is required, the length, for example, of a wave or the smallest or largest radius can be adapted accordingly.

Alternatively, for example, the predominantly axially oriented part 124 can have slots along the circumference of the seal ring 100. The slots can extend from the end 126 of the predominantly axially oriented part 124 facing away from the predominantly radially oriented part 122 towards the predominantly radially oriented part 122. Due to the slots the remaining metal parts of the predominantly axially oriented part 124 of the metal reinforcement 120 have space to move closer to one another (or move away from one another) in the event of an acting of a radial force on the predominantly axially oriented part 124 and thus make possible the elastic deformability. In contrast thereto, a continuously round metal reinforcement has no possibility to allow an elastic deforming (with the exception of a very slight negligible omnipresent elastic deformability of significantly less than 0.2 percent of the previously defined distance) in the event of the occurrence of radial forces.

Due to the definition of the elastic minimum deformability in the radial direction 128 depending on the distance between the predominantly radially oriented part 122 and the end 126 of the predominantly axially oriented part 124 facing away from the predominantly radially oriented part 122, i.e., essentially the length of the predominantly axially oriented part 124 in a radial cross-section, the described principle is defined independent of the size (the diameter) of the seal ring 100. For seal rings having a diameter of 50 to 120 mm, the elastic minimum deformability can also be specified, for example, as an absolute value. In other words, the predominantly axially oriented part 124 can be configured such that the predominantly axially oriented part 124 on the end 126 facing away from the predominantly radially oriented part 122 is elastically deformable in the radial direction 128 by more than 0.2 mm, more than 0.3 mm, more than 0.5 mm, more than 0.8 mm, or more.

The annular metal reinforcement 122 can have, for example, an essentially L-shaped or V-shaped (radial) cross-section. For example, the predominantly radially oriented part 122 and the predominantly axially oriented part 124 can enclose an angle in a radial cross-section between 85° and 160° (or between 90° and 140°, or between 95° and 120°), such as, e.g., 85°, 90°, 95°, 100°, 105°, 110°, 120°, or 130°.

Furthermore, the metal reinforcement 120 can be comprised of a plurality of parts. Alternatively the metal reinforcement 120 can be configured one-piece in order to reduce the manufacturing costs. For example, the metal reinforcement 120 can be made from a metal plate having a thickness between 0.2 mm and 0.6 mm, or between 0.3 mm and 0.5 mm. Furthermore, the metal reinforcement 122 can optionally be a stamped metal plate.

Due to the possible different geometries it can be achieved that the metal only deforms in the elastic region. With steel, for example, the metal itself can be elastically deformed only by up to 0.2 percent. The additional elastic deformability can be achieved by the corresponding geometry of the metal reinforcement 120.

The outer geometry of the seal ring 100 is determined primarily by the shape of the annular elastomer body 110, since this is normally in contact with the surface of the receiving bore and a moving part (e.g., a shaft) leading through the seal ring. In addition to other possibilities the annular elastomer body 110 can have, e.g., an essentially U-shaped cross-section, as is also shown in the example of FIG. 2. Here “essentially U-shaped” means that the elastomer body 110 has a U-shaped basic shape, but can have different-length side parts and bulges, beads, or recesses in the side parts or the base part or similar. The essentially U-shaped cross-section can be oriented, for example, such that the two side parts of the U-shaped cross-section are predominantly axially oriented and the base of the U-shaped cross-section is predominantly radially oriented, as is also shown in the example of FIG. 2.

Here the metal reinforcement 120 can be embedded, for example, in the base and the outer-lying side surfaces (outer-lying with respect to the midpoint of the seal ring) of the U-shaped cross-section.

Optionally, additionally, or alternatively the outer-lying side surfaces of the U-shaped cross-section in one region of the predominantly radially oriented part 122 of the metal reinforcement 120 can have a radially outwardly directed bead 150, so that in the event of an installation of the seal ring into a receiving bore the bead 150 is in contact with the receiving bore. The bead can then primarily assume the seal function on the side of the seal ring facing the receiving bore. The bead 150 can be disposed, for example, in the vicinity of the end 126 of the predominantly axially oriented part 124 facing away from the predominantly radially oriented part 122, since there the elastic deformability is greatest. In other words, the bead 150 can be disposed, for example, closer to the end 126 of the predominantly axially oriented part 124 facing away from the predominantly radially oriented part 122 than to the predominantly radially oriented part 122.

The elastomer body 110 can be comprised, for example, of a rubber elastomer or a thermoplastic polymer, in particular polyurethane, or another elastomer, or a mixture of elastomers.

The metal reinforcement 120 can protrude partially from the elastomer body 110 or be exposed on the surface of the seal ring 100. However, in order to prevent a contact of the metal reinforcement with moving parts, the metal reinforcement 120 can also be completely surrounded by the elastomer body 110.

In addition to the previously described necessary, optional, additional, or alternative designs of the seal ring 100, FIG. 1 shows an optional, additional, or alternative garter spring 130 and an optional, additional, or alternative seal lip 140 that can be part of the elastomer body 110. For example, in the installed state the seal lip 140 is in contact with the moving part leading through the seal ring 100. Due to the garter spring 130 the pressure of the seal lip 140 on the moving part can be significantly more reliably ensured and thus the seal function of the seal ring 100 can be more reliably realized.

FIG. 2 shows a view of a metal reinforcing 120 without elastomer body. The example shows a circular predominantly radially oriented part 122 and a predominantly axially oriented part 124, configured wave-shaped along the circumference of the metal reinforcement 120, connected thereto, as already described above.

Furthermore, FIG. 3 shows a three-dimensional cross-section of a part of a seal ring 100 consistent with the examples shown in FIGS. 1 and 2.

Some exemplary embodiments relate to a radial shaft seal ring including a resilient metal plate. Here the tolerance-compensating function is, for example, no longer exclusively assumed by the elastomer layer (that part of the elastomer body that lies between the metal reinforcement and the receiving bore), but (additionally) by the metal reinforcement part. In order to make possible this spring effect, the metal part can be designed in the manner of a bottle cap. For example, with simultaneous reduction of the metal-plate thickness (e.g. to 0.3 to 0.5 mm) and the use of a suitable material (e.g. soft to spring-like material or cold-rigid metal plate) a significantly flatter and (partially or completely) independent-of-the-viscoelastic-behavior-of-the-elastomer spring characteristic curve can be achieved. A bead in the vicinity of the end side can assume the seal function because the metal part has the smoothest characteristic curve.

The seals can thereby be installed in the bore significantly more easily with significantly higher minimum holding forces. Many of the previous problems can thereby be solved. At the same time, for example, the tolerances of bores and seals can be extended. The proposed principle can be realized without significant influence on the manufacturing costs. Only the costs for drawing tools can be higher due to two additional sink erosion processes.

In principle, all metal-part constructions can be used that have a spring effect.

The features disclosed in the foregoing description, in the claims that follow, and in the drawings can be relevant individually, as well as in any combination, to the realization of the invention in its various embodiments.

Although some aspects of the present invention have been described in the context of a device, it is to be understood that these aspects also represent a description of a corresponding method, so that a block or a component of a device is also understood as a corresponding method step or as a characteristic of a method step, for example a method for manufacturing or operating a filter cartridge. In an analogous manner, aspects which have been described in the context of or as a method step also represent a description of a corresponding block or detail or feature of a corresponding device.

The above-described exemplary embodiments represent only an illustration of the principles of the present invention. It is understood that modifications and variations of the arrangements and details described herein will be clear to other persons of skill in the art. It is therefore intended that the invention be limited only by the scope of the following patent claims, and not by the specific details which have been presented with reference to the description and the explanation of the exemplary embodiments.

### REFERENCE NUMBER LIST

100 Seal ring
110 Elastomer body
120 Metal reinforcement
122 Predominantly radially oriented part
124 Predominantly axially oriented part
126 End of the predominantly axially oriented part facing away from the predominantly radially oriented part
128 Radial direction
130 Garter spring
140 Seal lip
150 Bead

1. A seal ring comprising:
an annular elastomer body; and
an annular metal reinforcement at least partially embedded in the elastomer body, wherein the metal reinforcement includes a predominantly radially oriented part and a predominantly axially oriented part, wherein an end of the predominantly axially oriented part spaced from the predominantly radially oriented part is elastically deformable in a radial direction by more than 2% of a distance from the predominantly radially oriented part to the end of the predominantly axially oriented part.

2. The seal ring according to claim 1, wherein the end of the predominantly axially oriented part is configured wave-shaped along a circumference of the seal ring.

3. The seal ring according to claim 1, wherein the predominantly axially oriented part includes slots extending from the end of the predominantly axially oriented part towards the predominantly radially oriented part.

4. The seal ring according to claim 1, wherein the end of the predominantly axially oriented part is elastically deformable by more than 8% of the distance from the predominantly radially oriented part to the end of the predominantly axially oriented part.

5. The seal ring according to claim 1, wherein the end of the predominantly axially oriented part is elastically deformable in the radial direction by more than 0.2 mm.

6. The seal ring according to claim 1, wherein the annular metal reinforcement has a substantially L-shaped or a substantially V-shaped cross-section.

7. The seal ring according to claim 1, wherein the predominantly radially oriented part and the predominantly axially oriented part enclose an angle from 85° to 160°.

8. The seal ring according to claim 1, wherein the metal reinforcement is configured one-piece.

9. The seal ring according to claim 1, wherein the metal reinforcement is comprised of a metal plate having a thickness of from 0.2 mm to 0.6 mm.

10. The seal ring according to claim 1, wherein the metal reinforcement is a stamped metal plate.

11. The seal ring according to claim 1, wherein the annular elastomer body includes a substantially U-shaped cross-section, wherein a first side part and a second side part of the U-shaped cross-section are predominantly axially oriented and a base of the U-shaped cross-section is predominantly radially oriented.

12. The seal ring according to claim 11, wherein the metal reinforcement is embedded in the base and in the first side part of the of the U-shaped cross-section, the first side part of the U-shaped cross-section lying radially outward of the second side part of the U-shaped cross-section.

13. The seal ring according to claim 12, wherein the first side part includes a radially outwardly directed bead in a region of the predominantly radially oriented part of the metal reinforcement.

14. The seal ring according to claim 1, wherein the metal reinforcement is completely surrounded by the elastomer body.

15. The seal ring according to claim 1, wherein the elastomer body is comprised of polyurethane.

16. The seal ring according to claim 1,
wherein the end of the predominantly axially oriented part is configured wave-shaped along a circumference of the seal ring,
wherein the predominantly radially oriented part and the predominantly axially oriented part enclose an angle from 85° to 160°,
wherein the metal reinforcement is configured one-piece and is comprised of a metal plate having a thickness of from 0.2 mm to 0.6 mm,
wherein the annular elastomer body includes a substantially U-shaped cross-section,
wherein a first side part and a second side part of the U-shaped cross-section are predominantly axially oriented and a base of the U-shaped cross-section is predominantly radially oriented,
wherein the metal reinforcement is embedded in the base and in the first side part of the of the U-shaped cross-section, the first side part of the U-shaped cross-section lying radially outward of the second side part of the U-shaped cross-section, and
wherein the metal reinforcement is completely surrounded by the elastomer body.

17. A seal ring comprising:
an annular elastomer body; and
an annular metal reinforcement at least partially embedded in the elastomer body, the annular metal reinforcement including a predominantly radially oriented part and a predominantly axially oriented part, the predominantly axially oriented part including an end spaced from the predominantly radially oriented part,
wherein the annular metal reinforcement is sufficiently elastically deformable to allow the end of the predominantly axially oriented part to move in a radial direction a distance greater than 2% of a distance from the predominantly radially oriented part to the end of the predominantly axially oriented part.

18. The seal ring according to claim 17, wherein the end of the predominantly axially oriented part is configured wave-shaped.

19. The seal ring according to claim 17, wherein the predominantly axially oriented part includes slots extending from the end of the predominantly axially oriented part towards the predominantly radially oriented part.

20. The seal ring according to claim 17, wherein the distance greater than 2% of the distance from the predominantly radially oriented part to the end of the predominantly axially oriented part comprises a distance greater than 8% of the distance from the predominantly radially oriented part to the end of the predominantly axially oriented part.
